(19) United States
(12) Patent Application Publication
(10) Pub. No.: US 2025/0139103 A1
(43) Pub. Date: May 1, 2025

(54) Systems and Methods for Query Cancellation

(71) Applicant: Uber Technologies, Inc., San Francisco, CA (US)

(72) Inventor: Atri Sharma, Bangalore (IN)

(21) Appl. No.: 18/598,874

(22) Filed: Mar. 7, 2024

(30) Foreign Application Priority Data
Oct. 25, 2023 (IN) 202321072510

(51) Int. Cl. G06F 16/2455; G06F 16/2453

(52) U.S. Cl. CPC G06F 16/24565; G06F 16/24545

(57) ABSTRACT

Systems and methods for query cancellation. The system can receive a query, the query may be associated with one or more requests executable by a computing system. The method includes generating, using a machine-learned model, a query cost for the query, wherein the query cost is indicative of an estimated performance of the computing system. The method includes, based on the query cost, cancelling the query before completing execution of the one or more requests by the computing system.

### FIELD

The present disclosure generally relates to using machine-learned models to cancel queries that may impact computing operations of a computing system.

### BACKGROUND

Long running queries may consume considerable amounts of computing resources and negatively impact a computing system. For instance, systems or applications which handle high volume data may serve millions of queries per day. Queries which take an extended time to execute or require extensive computing resources may decrease the overall performance of the computing system or cause an outage.

### SUMMARY

Aspects and advantages of embodiments of the present disclosure will be set forth in part in the following description, or may be learned from the description, or may be learned through practice of the embodiments.

In an example aspect, present disclosure provides an example computing system. The example computing system includes one or more processors and one or more non-transitory, computer readable medium storing instructions that are executable by the one or more processors to cause the computing system to perform operations. The example operations include receiving a query, the query associated with one or more requests executable by the computing system. The example operations include generating, using a machine-learned model, a query cost for the query, wherein the query cost is indicative of an estimated performance of the computing system. The example operations include, based on the query cost, cancelling the query before completing execution of the one or more requests by the computing system.

In some examples, generating a query cost for the query includes accessing index data indicative of a location of data ingested by the computing system, wherein the data is associated with the query. In some examples, generating a query cost for the query includes identifying a field and an operator for the query, wherein the field is indicative of the location of the data based on the index data and the operator is indicative of an action to be taken on the data.

In some examples, generating a query cost for the query includes predicting a static query cost based on the field and the operator, wherein the static query cost is indicative of computing resources to be consumed by executing the query. In some examples, generating a query cost for the query includes receiving performance metrics associated with the computing system. In some examples, generating a query cost for the query includes generating the query cost based on the static query costs and the performance metrics.

In some examples, the performance metrics are indicative of at least one of: (i) an associated latency, (ii) a CPU utilization, (iii) an associated running time, or (iv) a queue of queries to be executed.

In some examples, the operations include determining, based on the query cost, a probability of decreasing performance of the computing system by executing the query.

In some examples, the operations include determining, based on the query cost, a probability of increasing performance of the computing system by cancelling the query.

In some examples, the machine-learned model is configured to receive feedback data associated with a cancellation score, wherein the cancellation score is associated with one or more cancelled queries. In some examples, the machine-learned model is configured to determine, based on the feedback data, one or more updated query costs associated with respective queries.

In some examples, the cancellation score is associated with an actual performance of the computing system in response to the one or more cancelled queries.

In some examples, the operations include generating a cancellation trigger based on the query cost. In some examples, the operations include invoking the cancellation trigger, wherein invoking the cancellation trigger cancels the query.

In some examples, invoking the cancellation trigger includes determining a type of cancellation trigger, wherein the type of cancellation trigger is associated with a signal to cancel the query. In some examples, invoking the cancellation trigger includes determining a cancellation controller from a plurality of cancellation controllers, based on the type of cancellation trigger.

In some examples, the plurality of cancellation controllers includes at least one of: (i) an early termination controller, (ii) a user-context-based controller, or (iii) a utilization controller.

In some examples, the signal to cancel the query is indicative of a cancellation status associated with the query.

In another aspect, the present disclosure provides an example computer-implemented method. The example computer-implemented method includes receiving a query, the query associated with one or more requests executable by the computing system. The example computer-implemented method includes generating, using a machine-learned model, a query cost for the query, wherein the query cost is indicative of an estimated performance of the computing system. The example computer-implemented method includes, based on the query cost, cancelling the query before completing execution of the one or more requests by the computing system.

In some examples, generating a query cost for the query includes accessing index data indicative of a location of data ingested by the computing system, wherein the data is associated with the query. In some implementations, generating a query cost for the query includes identifying a field and an operator for the query, wherein the field is indicative of the location of the data based on the index data and the operator is indicative of an action to be taken on the data.

In some examples, generating a query cost for the query includes predicting a static query cost based on the field and the operator, wherein the static query cost is indicative of computing resources to be consumed by executing the query. In some implementations, generating a query cost for the query includes receiving performance metrics associated with the computing system. In some implementations, generating a query cost for the query includes generating the query cost based on the static query costs and the performance metrics.

In some examples, the performance metrics are indicative of at least one of: (i) an associated latency, (ii) a CPU utilization, (iii) an associated running time, or (iv) a queue of queries to be executed.

In some examples, the example method includes determining, based on the query cost, a probability of decreasing performance of the computing system by executing the query.

In some examples, the example method includes determining, based on the query cost, a probability of increasing performance of the computing system by cancelling the query.

In some examples, the machine-learned model is configured to receive feedback data associated with a cancellation score, wherein the cancellation score is associated with one or more cancelled queries. In some implementations, the machine-learned model is configured to determine, based on the feedback data, one or more updated query costs associated with respective queries.

In another example aspect, the present disclosure provides for one or more example non-transitory computer-readable media storing instructions that are executable to cause one or more processors to perform operations. The example operations include receiving a query, the query associated with one or more requests executable by the computing system. The example operations include generating, using a machine-learned model, a query cost for the query, wherein the query cost is indicative of an estimated performance of the computing system. The example operations include, based on the query cost, cancelling the query before completing execution of the one or more requests by the computing system.

Other example aspects of the present disclosure are directed to other systems, methods, apparatuses, tangible non-transitory computer-readable media, and devices for performing functions described herein. These and other features, aspects and advantages of various implementations will become better understood with reference to the following description and appended claims. The accompanying drawings, which are incorporated in and constitute a part of this specification, illustrate implementations of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an example computing ecosystem according to example aspects of the present disclosure.

FIG. 2 depicts an example data flow pipeline according to example aspects of the present disclosure.

FIG. 3 depicts an example data flow pipeline according to example aspects of the present disclosure.

FIG. 4 depicts an example data flow pipeline according to example aspects of the present disclosure.

FIG. 5 depicts an example data flow pipeline according to example aspects of the present disclosure.

FIG. 6 depicts a flowchart diagram of an example method according to example aspects of the present disclosure.

FIG. 7 depicts an example computing ecosystem according to example aspects of the present disclosure.

### DETAILED DESCRIPTION

Generally, the present disclosure is directed to techniques for cancelling queries. Techniques according to the present disclosure provide improved stability of computing systems using, for example, a query cancellation service that cancels queries proactively and/or retroactively which have a high probability of causing performance issues. The query cancellation service may receive a query, generate a cost associated with executing the query, and generate a cancellation trigger to cancel the query based on performance metrics of the computing system. According to some embodiments, the query cancellation service can implement one or more query cancellation models to analyze queries and determine static query costs based on the action to be taken. The query cancellation model may process the static query cost and performance metrics associated with the computing system to determine a probability of the computing system experiencing decreased performance. In some examples, the query cancellation service may cancel a query and receive feedback on the performance of the computing system after the query has been cancelled to improve the static cost(s) or query cost(s) generated by the query cancellation model(s). In some examples, the query cancellation service may identify problematic queries (e.g., queries that have previously caused performance issues) and cancel the problematic queries proactively.

For example, application clients, microservices, or other computer processes may interact with a storage system to retrieve or interact with data. The storage system may store data needed for the application client or computer process to execute properly. Example interactions between a computer process and a storage system may include reading, writing, updating, deleting, or storing operations that store, access, or interact with data in the storage system.

The storage system may include computing resources to serve incoming requests (e.g., queries) to interact with data. For example, the storage system may include search nodes for searching the storage system to retrieve or interact with data defined in the query. In some examples, the storage system may include a plurality of controller nodes for orchestrating and managing the computing resources of the search nodes. For instance, the storage system may include a search engine for orchestrating the search, retrieval, and interactions of data across the storage system. While examples herein describe a storage system including controller nodes and search nodes, the storage system may be any storage system which receives a query and returns a result.

The query cancellation service may access a database index to determine the location of data within the storage system and analyze a query to generate a static cost for the query. For example, as new data is stored in the storage system, an index pointing to the location (e.g., field, column, etc.) where the data may be found may be generated to assist with quickly locating data. The query cancellation service may analyze the query to identify a defined location (e.g., field, column, etc.) and an operator (e.g., action to take on the data). For example, the query may indicate a field where data has been stored and an operator to indicate what action (e.g., update, delete, insert, etc.) should be taken on the data within the specified field. The query cancellation service may utilize the index and determine, based on the field and operator, a static cost associated with executing the query. In some examples, the query cancellation service may assign an associated cost to an operator. For example, an index may indicate that a field has one million distinct values, and a query may identify the field requesting a full SORT operator to sort the one million distinct values. Full sort operators may be assigned a high associated cost due to the intensive computing resources required to perform the operation. In some examples, the query cancellation service may predict a high static cost for the query due to the high cost associated with the full SORT operator and the increased number of distinct values stored in the field.

The query cancellation service may utilize the static cost for the query and performance metrics of the storage system to generate a query cost(s) associated with executing the query (e.g., a computational cost). The query cost may indicate predicted performance of the storage system if the query is executed or cancelled. For example, the storage system may be executing a plurality of queries in parallel and may output metrics associated with available computing resources to serve additional queries. The query cancellation service may generate a query cost for queries and generate a cancellation trigger to cancel one or more queries which may cause performance issues for the storage system. For example, the query cancellation service may determine, based on the performance metrics, the search nodes have a CPU utilization of 80% and a current queue of queries to be executed that will likely increase CPU utilization to 95%. The query cancellation service may determine, based on the static cost for an incoming query that executing the query will increase CPU utilization beyond 100% causing performance issues. The query cancellation service may generate a high or expensive query cost associated with predicted performance issue and generate a cancellation trigger to cancel the query to prevent the performance issue. Query costs may include integers, percentages, keywords, or any system of measurement which can be assigned to a query. The query cancellation service may include preset or dynamically updated thresholds/limits which generate cancellation triggers when the thresholds/limits are met or exceeded.

The query cancellation service may cancel one or more queries and determine, based on feedback (e.g., performance metrics after a query has been cancelled), that one or more parameters of the query cost calculation should be updated. For example, the query cancellation service may generate a low query cost for a respective query and determine the query should be executed. In some examples, the query may result in performance issues. The query cancellation service may receive feedback data indicating the executed query which caused performance issues and update one or more parameters of the query cancellation model to generate an increased query cost for the respective query. In some examples, the query cancellation service may update thresholds or limits for determining whether to cancel a query.

The technology of the present disclosure may provide several benefits and technical effects. For instance, the technology of the present disclosure provides proactive monitoring and cancellation of rogue queries which may produce performance issues and prevent more critical queries from being served. As such, the technology may increase the stability of the storage system by preventing performance issues before they occur and prevent widespread issues with upstream applications or services. The technology of the present disclosure may also help to increase the efficiency and management of storage systems without impacting performance due to the dynamic adjustment of the parameters to generate increasingly more accurate query costs. Moreover, by detecting conditions that may impact computing efficiency (e.g., processing, resources, etc.) for the storage system and making adjustments, the technology of the present disclosure may improve the stability and reliability of the storage systems.

Reference now will be made in detail to embodiments, one or more example(s) of which are illustrated in the drawings. Each example is provided by way of explanation of the embodiments, not limitation of the present disclosure. In fact, it will be apparent to those skilled in the art that various modifications and variations may be made to the embodiments without departing from the scope of the present disclosure. For instance, features illustrated or described as part of one embodiment may be used with another embodiment to yield a still further embodiment. Thus, it is intended that aspects of the present disclosure cover such modifications and variations.

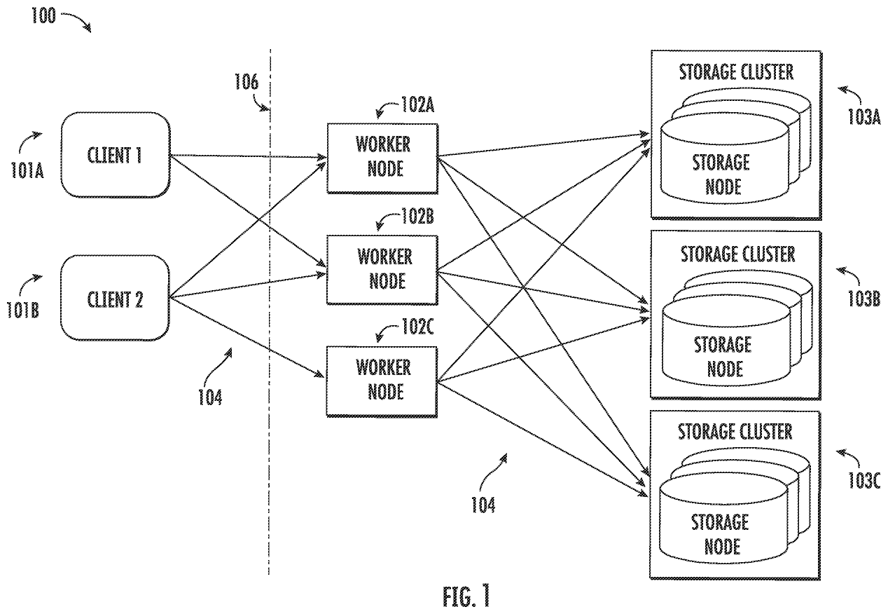

FIG. 1 depicts an example computing ecosystem according to example aspects of the present disclosure. The example system 100 may include one or more clients 101A,101B, worker nodes 102A, 102B, 102C, and storage clusters 103A,103B,103C associated with the one or more worker nodes 102A,102B,102C. In some examples, the clients 101A,101B may interact with the worker nodes 102A, 102B,102C. For instance, the clients 101A,101B may transmit queries 104 (e.g., API requests) through an API gateway 106 to interact with data stored in the storage clusters 103A,103B,103C. For example, the worker nodes 102A, 102B, 102C may receive the queries 104 from the API gateway 106 and facilitate the processing of the queries 104 by directing the query 104 to the correct storage clusters 103A,103B,103C for processing.

With respect to examples as described herein, the system 100 may be implemented on a server, on a combination of servers, or on a distributed set of computing devices which communicate over a network such as the Internet. For example, the system 100 may be distributed using one or more physical servers, virtual private servers, containers, cloud computing, etc. In some examples, the system 100 may be implemented as a part of or in connection with the clients 101A,101B, where, for example, the clients 101A,101B may be a mobile application client, web browsing client, or desktop application client deployed on a remote computing device that accesses one or more microservices of an application via a client-server relationship. A microservice may include one or more software applications architected into independent services (e.g., microservices) that communicate over APIs (application programming interfaces). The clients 101A,101B may include computer hardware or software which access a service (e.g., microservice) for one or more applications or systems. For instance, the clients 101A,101B may be included in a client-server relationship in which the server allows the clients 101A,101B to access the service by way of a network (e.g., the internet). In some examples, the clients 101A,101B may transmit queries 104 to interact with microservices over the network. While examples herein describe a microservice architecture, the system 100 may be any computing system in a client-server relationship (e.g., monothetic architecture, etc.).

In some examples, the system 100 may include a proxy to facilitate requests 104 from clients 101A,101B to microservices. For instance, the system may include an API gateway 106 which serves as a single entryway for client 101A,101B interactions with microservices. The API gateway 106 may include a software application between one or more clients (e.g., clients 101A,101B) and a set of backend microservices. In some examples, the API gateway 106 serves as a reverse proxy to accept API calls from the client applications (e.g., clients 101A,101B). In some examples, the API gateway 106 may forward the API calls (e.g., queries 104) to the appropriate microservice. In some examples, the API gateway 106 may be deployed on server within a shared network associated with the worker nodes 102A,102B,102C and storage clusters 103A,103B,103C. For instance, the API gateway 106 may be deployed on one or more servers within the shared network which receives inbound traffic and proxies outbound traffic for the worker nodes 102A,102B, 102C and storage clusters 103A,103B,103C.

The clients 101A,101B may transmit queries 104 to interact with one or more backend microservices or applications. For example, the queries 104 may be an API request. For instance, the query 104 may include a GET, POST, PUT, DELETE, or BATCH function. The GET, POST, PUT, DELETE, or BATCH function may perform operations on data associated with respective microservices. For instance, a GET request may retrieve data, a POST request may publish data, or a DELETE request may delete data for a respective microservice, etc. In some examples, the web server (e.g., server within the client server relationship) may use an API to facilitate the queries 104 via the API gateway 106. By way of example, the API gateway 106 may receive a query 104 and proxy or route the query 104 to the appropriate microservice. In some examples, the microservices may be associated within one or more worker nodes 102A, 102B,102C. For instance, the microservices may run on the worker nodes 102A,102B,102C. In some examples, worker nodes 102A, 102B, 102C may receive the query 104 and query (e.g., direct the query 104) one or more storage clusters 103A,103B,103C where data associated with the microservices may be stored to generate a query response.

For example, the system 100 may be implemented using one or more containers (e.g., standalone software package for a software application) using a container service, or on VMs (virtual machines) within a shared network. A container service may be a cloud service that allows developers to upload, organize, run, scale, manage, and stop containers using container-based virtualization to orchestrate their respective actions. A VM may include virtual computing resources which are not limited to a physical computing device. For example, the worker nodes 102A, 102B,102C may be deployed in containers controlled by a container orchestration service. In some examples, the container orchestration service may manage the computing resources of worker nodes 102A, 102B, 102C. For instance, the worker nodes 102A, 102B, 102C (e.g., microservices) may be included in a single application or system. In some examples, the worker nodes 102A,102B, 102C may collectively receive queries 104 from the clients 101A, 101B and produce an aggregated response.

By way of example, client 101A may transmit a query 104 to an application including microservice A, microservice B, and microservice C running on worker nodes 102A, 102B, and 102C respectively. The query 104 may include a request to perform an operation on data associated with microservice A and microservice B. In some examples, microservice A may utilize independent computing resources (e.g., worker nodes 102A) to execute a first portion of the query 104 and microservice B may subsequently or in parallel utilize independent computing resources (e.g., worker node 102B) to execute a second portion of the query 104. An aggregated response to the query 104 may be generated and proxied via the API gateway to client 101A.

The container orchestration service may manage the computing resources across the worker nodes 102A, 102B, 102C to orchestrate the execution of queries 104. In some examples, the container orchestration service may determine the worker nodes 102A, 102B, 102C do not have sufficient computing resources to execute queries 104. For instance, queries 104 may be associated with a latency (e.g., anticipated time for a response) requirement. The latency requirement may indicate the time in which a response is expected before adverse impacts (e.g., noticeable lag, delay, etc.) occur within the application client (e.g., clients 101A, 101B). In some examples, queries 104 may be prioritized over other queries 104. For instance, a query 104 to retrieve all available service offerings may be prioritized over a query to retrieve 6 months of previous order history. The container orchestration service may determine that the worker nodes 102A, 102B, 102C do not have sufficient computing resources to execute queries which satisfy latency requirements, satisfy prioritized queries 104 or any other defined parameters.

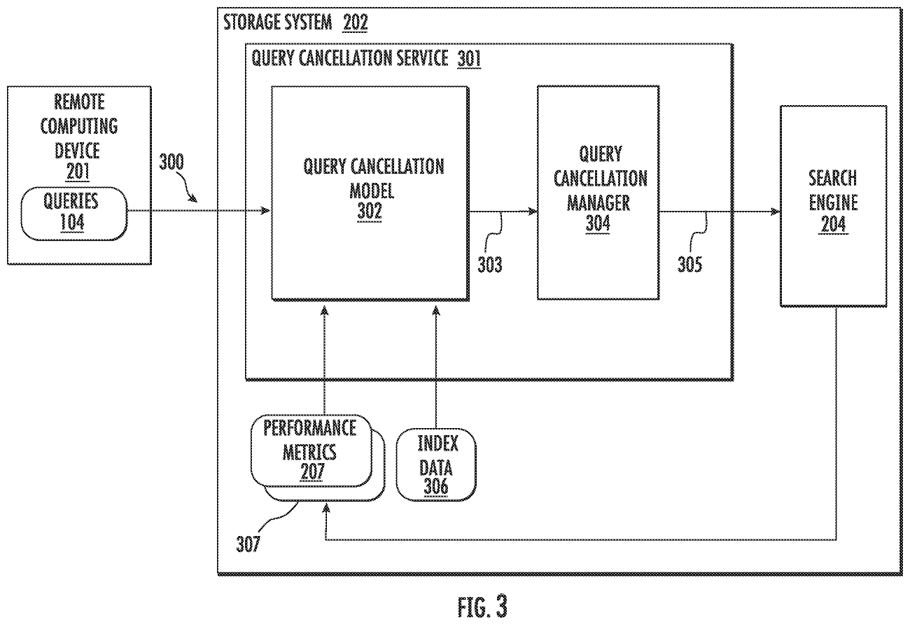

By way of example, the container orchestration service may determine the queries 104 from the clients 101A, 101B will exceed the computing resource capacity of the worker nodes 102A, 102B,102C and automatically scale the number of microservice instances (e.g., worker nodes 102A, 102B, 102C) based on traffic or resource utilization. In some examples, the container orchestration service may determine that scaling the number of microservice instances is not feasible based on computing resource constraints (e.g., maximum scale threshold). In some examples, a query cancellation service may be utilized to cancel queries 104 to prevent exceeding the computing resource capacity. An example of a query cancellation service cancelling queries 104 is further described with reference to FIG. 3.

In some examples, the storage clusters 103A,103B,103C may be deployed using an orchestration service. The orchestration service may be associated with the orchestration service which manages the worker nodes 102A, 102B, 102C, or an independent orchestration service. For instance, the storage clusters 103A,103B,103C may be included in a clustered file system. The clustered file system may be software which manages (e.g., orchestrates) one or more storage clusters 103A,103B,103C. In some examples, storage clusters 103A,103B,103C may support the storage nodes. For example, the storage clusters 103A,103B,103C may include a group of storage nodes. In some examples, the storage clusters 103A,103B,103C including the group of storage nodes may function as a storage unit. By way of examples, a storage cluster 103A,103B,103C may include three storage nodes and the storage clusters 103A,103B,103C may be accessible by a microservice (e.g., worker nodes 102A, 102B, 102C) as a single storage unit. In some examples, data may be stored across the storage nodes of the storage clusters 103A, 103B,103C and can be accessed as block storage (e.g., blocks of data stored across the storage nodes of the storage clusters 103A,103B,103C). For instance, the storage nodes may include a physical server with one or more HDDs (hard-disk drives) or SDD (solid-state drives). An HDD may include a storage device which may store data in the event of power loss to the storage device. An SDD may include a storage device which may always require power to store data. In some examples, the storage clusters 103A,103B,103C may include a controller (e.g., master) storage node which manages the storage nodes within the storage clusters 103A,103B,103C. For instance, the orchestration service may be deployed on a controller node within the storage clusters 103A,103B,103C to orchestrate the management of storage nodes. In some examples, the orchestration service may be deployed on a separate server independent from the storage nodes to control all storage clusters 103A, 103B, 103C.

The worker nodes 102A, 102B, 102C may receive the queries 104 from the API gateway 106 and direct the queries 104 to the storage clusters 103A,103B,103C to interact with the specified data and return a response. In some examples, the storage clusters 103A,103B,103C may receive the queries 104 and fail to execute the query 104 (e.g., perform the specified function) based on storage or computing resources. For instance, the storage clusters 103A,103B,103C may receive the queries 104 and determine there are insufficient computing resources to serve (e.g., execute) the query 104. For example, storage clusters 103A,103B,103C may include finite computing resources to serve incoming queries 104. In some examples, the volume of queries 104 may exceed the available computing resources of the storage clusters 103A,103B,103C. In some examples, an expensive queries 104 (e.g., query which requires substantial computing resources) may cause subsequent queries 104 to exceed available computing resources of the storage clusters 103A,103B,103C. In other examples, query parameters may not be satisfied with the currently available computing resources of the storage clusters 103A, 103B,103C.

By way of example, the system 100 may experience high load times or increased traffic from client devices (e.g., clients 101A, 101B). For instance, an application (e.g., system 100) which provides entities that are available as lunch options may experience an increased number of queries 104 during the hours of 11 AM-2 PM. In some examples, the number of queries 104 may exceed the available computing resources of the storage clusters 103A,103B,103C. In some examples, the number of queries 104 may cause poor performance for the system 100. For instance, as storage clusters 103A,103B,103C serve large queues of queries 104, queries 104 which are at the bottom of the queue may experience delayed responses, latency issues, and cause application performance issues. In some examples, the performance issues may cause a complete outage. For instance, the storage clusters 103A,103B,103C may experience an influx of queries 104 which causes the storage clusters 103A,103B,103C completely to terminate processing queries 104.

In some examples, the query cancellation service may determine the number of queries 104 will exceed computing resources of the storage clusters 103A, 103B,103C and cancel one or more queries 104 to avoid exceeding computing resources or prevent performance issues. For instance, the query cancellation service may determine a query 104 is expensive (e.g., a high resource constrained query 104) and cancel the query 104 to preserve computing resources of the storage clusters 103A,103B,103C for other queries 104. In other examples, the query cancellation service may proactively (e.g., before executing the query 104) or retroactively (e.g., after execution of the query 104 has begun) cancel queries 104 which may cause or have previously caused performance issues. An example of cancelling queries is further described with reference to FIG. 3.

In some examples, the query cancellation service may cancel queries based on a probability of the query exceeding computing resources of the storage clusters 103A,103B,103C and return a cancellation response. By way of example, the query cancellation service may predict the storage clusters 103A,103B,103C will receive an influx of queries 104 between 5 PM and 6 PM, based on historical performance statistics. The query cancellation service may cancel queries 104 determined to be expensive just prior to 5 PM due to the probability of the expensive query 104 and a predicted influx of queries 104 exceeding computing resources. The query cancellation service may cancel the queries 104 and generate a response. The response may include data indicating the reason why the query 104 was not executed. In some examples, the response may facilitate a retry (e.g., a second query 104) from the clients 101A, 101B. Example responses may include a response body indicating an error, error message, details regarding the error, or a status of the request 104. In some examples, the response may be associated with a status response code. Example status response codes may include standard client or server response codes (e.g., 400, 500, etc.) or custom response codes.

In some examples, the storage clusters 103A,103B,103C may execute a query 104 and return a success response. For instance, the storage clusters 103A,103B,103C may perform commands which satisfy functions (e.g., data operations) included in the query 104 and return a response. The response may be received by the worker nodes 102A,102B,102C and proxied through the API gateway 106 to the clients 101A, 101B. For instance, the web server associated with the client 101A,101B may receive an API response and provide the response to the client 101A,101B. In some examples, the response may update a user interface associated with the client 101A,101B. For instance, a remote computing device associated with the client 101A,101B may include a user interface element which displays user interface elements associated with the response. In some examples, the iterative process of clients 101A,101B interacting with microservices (e.g., worker nodes) and storage clusters 103A, 103B,103C may continue as a user interacts with the clients 101A,101B running on the remote computing device.

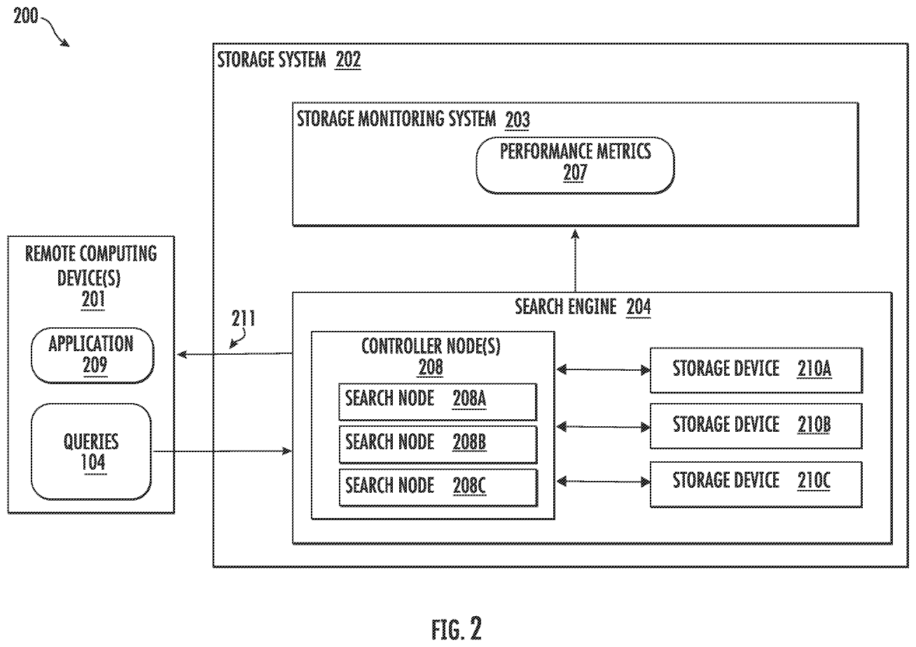

FIG. 2 depicts an example dataflow pipeline according to example aspects of the present disclosure. The following description of dataflow pipeline 200 is described within an example implementation in which a storage system 202 receives a query 104 from a remote computing device 201 associated with an application 209 (e.g., clients 101A,101B), processes the query 104 using a search engine 204 to interact within data across one or more storage devices 210A, 210B, 210C, and returns a query response 211. Additionally, or alternatively, one or more portions of the dataflow pipeline 200 may be implemented across a plurality of remote computing devices 201, worker nodes 102A, 102B, 102C, search engines 204 or storage systems 202.

The remote computing device 201 may include a mobile computing device, such as a smartphone, tablet computer, laptop computer, VR or AR headset device, and the like. As such, the remote computing device 201 may include components such as a microphone, a camera, a satellite receiver, and a communication interface to communicate with external entities using any number of wireless communication protocols. In some examples, the remote computing device 201 may store a designated application 209 in a local memory. For instance, the designated application 209 may be associated with a client application (e.g., client 101A, 101B) running on the remote computing device 201. In some examples, the memory may store additional applications executable by one or more processors of the remote computing device 201, enabling access and interaction with one or more host servers (e.g., worker nodes 102A, 102B, 102C) over one or more networks. For instance, the remote computing device 201 may communicate with the storage system 202 over one or more networks such as the internet.

The remote computing device 201 may be associated with a user and allow the user to interact with an application 209 (e.g., service entity, merchant, service provider, etc.). For example, in response to user input by a user, an application 209 (e.g., client 101A, 101B) may interact with the remote computing device 201 to transmit a query 104 to the storage system 202. For instance, the query 104 may request data to be displayed via an application 209 interface on a user interface of the remote computing device 201. In some examples, the user may select items or services through the application 209 on the remote computing device 201. In some examples, the application 209 running on remote computing device 201 (e.g., client 101A, 101B) may interact with one or more backend servers (e.g., worker nodes 102A, 102B, 102C) to request, update, or interact with data stored in the storage system 202. For instance, the remote computing device 201 may transmit one or more queries 104 to interact with data associated with items or services stored in the storage system 202 and render a display of items or services on the remote computing device 201, based on receiving a query response 211 from the storage system 202.

The storage system 202 may include a number of subsystems and components for performing various operations. For example, the storage system 202 may include a storage monitoring system 203 and a search engine 204. In some examples, the storage system 202 may include one or more computing devices or server computing devices, operating according to various computing architectures (e.g., microservices architectures, monolithic architectures, etc.). The storage system 202 may be implemented on a server, on a combination of servers, or on a distributed set of computing devices which communicate over a network such as the Internet. For example, the storage system 202 may be a distributed file system. A distributed file system may include a set of client and server services that allow servers to organize distributed file shares into a single distributed file system. In some examples, the storage system 202 may include a file system that enables clients (e.g., clients 101A,101B) to access file storage via the search engine 204 from multiple hosts through a computer network. In some examples, the storage system 202 may include any type of file system where data may be stored. For instance, the storage system 202 may include various types of storage devices 210A, 210B, 210C such as HDD storage or SDD storage. In some examples, the storage system 202 may manage various types of storage in a distributed manner.

The storage system 202 may include a storage monitoring system 203. The storage monitoring system 203 may include software running on one or more servers within the storage system 202 which monitors the performance and utilization of the storage system 202. For instance, the storage monitoring system 203 may include software that provides storage administrators with detailed data associated with the individual storage components (e.g., servers, nodes, clusters, etc.) within the storage system 202, traffic (e.g., inbound/outbound requests), or performance (e.g., latency). In some examples, the storage monitoring system 203 may include regularly monitoring availability, performance, exceptions, and configurations. For example, the storage monitoring system 203 may indicate when or if an issue needs to be resolved within the storage system 202.

Performance metrics 207 may include data indicating the health or performance of the storage system 202. For instance, performance metrics 207 may include available computing resources of the storage system 202, average latency of queries 104, a number of queued queries 104, historical performance, etc. The performance metrics 207 may indicate the performance of the storage system 202 at a point in time or over time. For instance, performance metrics 207 may include average metrics or specific metrics during specific times (e.g., high load times). In some examples performance metrics 207 may include itemized metrics for specific system components or subsystems. For instance, performance metrics 207 may include metrics for the performance of only the search engine 204. In some examples, performance metrics 207 may include the performance of the worker nodes 102A, 102B, 102C. For instance, performance metrics 207 may indicate that worker nodes 102A, 102B, 102C are experiencing performance issues based on an associated latency with executing queries 104.

In some examples, performance metrics 207 may include a latency metric, CPU (central processing unit) metric, a query running time metric, or a queuing metric. A latency metric may be an associated latency for respective queries 104. For instance, a query 104 may indicate a latency requirement in the body of the request message. Latency may indicate a threshold time where a response to the query 104 is expected before performance delays (e.g., lag time, buffering, etc.) occur within the application 209. A CPU metric may include CPU utilization of the storage system 202, worker nodes 102A, 102B, 102C, or any computing system used to serve queries 104. The query running time metric may include actual or average running times (e.g., execution time) of queries 104. Examiner running times may include running times between 0 and 100 milliseconds (ms). In some examples, running times may exceed milliseconds and reach seconds, minutes, or hours. A queuing metric may include an average queue depth of search nodes 208A, 208B, 208C. A queue depth may indicate the number of queries 104 which may be executed in parallel by the storage system 202. In some examples, the queue of queries 104 may indicate a queue of queries waiting to be executed.

By way of example, the storage monitoring system 203, may detect that one or more search nodes 208A, 208B, 208C within the search engine 204 has failed to execute consecutive queries 104 by receiving performance metrics 207 from the search engine 204. The storage monitoring system 203 may alert a storage system administrator of the issue to address failures prior to reliant microservices or applications sustaining adverse effects. In some examples, the storage monitoring system 203 may collect performance metrics 207 and provide the performance metrics to a query cancellation service. For instance, the query cancellation service may proactively or reactively identify potential issues with the execution of queries 104 and cancel the query 104. An example of the query cancellation service is further described with reference to FIG. 3.

The storage system 202 may include a search engine 204. The search engine 204 may include software controlling one or more nodes (e.g., controller nodes 208, search nodes 208A, 208B, 208C) to execute searches (e.g., queries 104) within the storage system 202. In some examples, the search engine 204 may be associated with storage devices 210A, 210B, 210C. In some examples, the search engine 204 may control the distribution and processing of queries 104 across the storage system 202. For instance, the search engine 204 may include software configured to receive queries 104, maintain an index of data stored across the storage devices 210A, 210B, 210C, crawl (e.g., search, traverse, etc.) the storage devices 210A, 210B, 210C, and return a query response 211.

In some examples, the search engine 204 may be implemented using one or more containers (e.g., standalone software package for a software application) using a container service, or on VMs (virtual machines) within a shared network. For instance, the search engine 204 may include software replicated across a plurality of storage clusters (e.g., storage clusters 103A, 103B, 103C) within the storage system 202. For example, as the volume of queries 104 increases, the storage system 202 may scale the search engine 204 (e.g., storage clusters 103A, 103B, 103C) to meet the increased demand.

By way of example, the search engine 204 may include controller nodes 208. The controller nodes 208 may control one or more search nodes 208A, 208B, 208C within the search engine 204. Search nodes 208A, 208B, 208C may include one or more crawlers (e.g., processors or computing resources) configured to execute queries 104. For example, search nodes 208A, 208B, 208C may be configured to perform functions specified by queries 104 on data across one or more storage devices 210A, 210B, 210C. By way of example, the search engine 204 may receive a query 104 from the remote computing device 201. A search engine may access an index indicating a field expression (e.g., column name, field name, etc.) pointing to the location of data in a table. The index may be generated as data is stored in the storage system 202 and updated as updates occur to data. The search engine 204 may analyze the query 104 to determine, based on the index, the location of data specified by the query and an action to be taken on the data. For instance, the search engine may determine the query 104 specifies a GET request and a filter operator to retrieve a filtered data set from column1, stored across one or more storage devices 210A, 210B, 210C. In some examples, the search engine 204 may determine the location of column1 based on the index and utilize the controller node 208 to assign the query 104 to a search node 208A, 208B, 208C for execution. The search node 208A, 208B, 208C may locate column1 within one or more storage devices 210A, 210B, 210C using the index, execute the filter operator and return the filtered result to satisfy the GET request (e.g., query 104). The search engine 204 may aggregate the results and transmit a query response 211 to the remote computing device 201. In some examples the query response 211 may be transmitted to the remote computing device from a microservice associated with the query 104.

In some examples, the search engine 204 may include a buffer table. For example, the search engine 204 may receive a plurality of queries 104 concurrently and may orchestrate the execution of queries 104 by generating a buffer table (e.g., queue of queries 104). The buffer table may allocate queries 104 to respective search nodes 208A, 208B, 208C. In some examples, the controller node 208 may assign queries 104 and manage the buffer table. For instance, search nodes 208A, 208B, 208C may include various searching capabilities (e.g., faster or slower processors), varying levels of available computing resources (e.g., current queue of queries 104), etc. The controller node 208 may assign queries 104 to respective search nodes 208A, 208B, 208C based on these parameters or requirements associated with the queries 104. For instance, queries 104 may be prioritized by microservices or be associated with latency requirements.

By way of example, the remote computing device 201 may transmit a first query associated with retrieving available services and a second query associated with retrieving previous service requests. Microservices may define one or more requirements indicating that the first query is of a higher priority than the second query due to the potential submission of a service request. In some examples, microservices may define a latency requirement. A latency requirement may indicate a threshold amount of time the remote computing device 201 (e.g., application 209) may wait to receive a query response 211 before performance issues (e.g., buffering, slow load times, etc.) occur. The controller nodes 208 may assign queries to respective search nodes 208A, 208B, 208C such that any parameters or requirements are satisfied. In some examples, there may be insufficient computing resources across the search nodes 208A, 208B, 208C to satisfy all parameters and requirements for all queries 104 received by the storage system. In some examples, a query cancellation service may cancel queries 104 which may cause downstream performance issues related to executing queries 104 which exceed the computing resources of the search nodes 208A, 208B, 208C. An example of the query cancellation service is further described with reference to FIG. 3.

FIG. 3 depicts an example dataflow pipeline according to example aspects of the present disclosure. The example dataflow pipeline 300 is described with an example implementation in which a storage system 202 utilizes a query cancellation service 301 to cancel queries 104 which may cause or are currently causing performance issues for the storage system 202. The query cancellation service 301 may include a machine-learned query cancellation model 302 and a query cancellation manager 304 configured to 304 proactively or retroactively cancel queries 104 received by the storage system 202. Additionally, or alternatively, one or more portions of the dataflow pipeline 300 may be implemented by the search engine 204, worker nodes 102A, 102B, 102C, or other computing systems.

The storage system 202 may include a query cancellation service 301 for cancelling rogue (e.g., problematic) queries 104 or queries 104 which may cause performance issues. The query cancellation service 301 may include software running on one or more servers of the storage system 202. In some examples, the query cancellation service 301 may be implemented on one or more worker nodes 102A, 102B, 102C. In other examples, the query cancellation service 301 may be implemented via the API Gateway 106.

In some examples, the query cancellation service 301 may be implemented using one or more containers (e.g., standalone software package for a software application). For instance, the query cancellation service 301 may be deployed using an orchestration service. The orchestration service may manage the computing resources across the query cancellation service 301 to orchestrate the cancellation of queries 104.

The query cancellation service 301 may include a machine-learned query cancellation model 302. The query cancellation model 302 may be or may otherwise include various machine-learned models such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks.

The query cancellation model 302 may be trained through the use of one or more model trainers and training data. The model trainers may be trained using one or more training or learning algorithms. One example training technique is backwards propagation of errors. In some examples, simulations may be implemented for obtaining the training data or for implementing the model trainer(s) for training or testing the model(s). In some examples, the model trainer(s) may perform supervised training techniques using training queries or training performance metrics. As further described herein, the training data may include simulated queries and simulated performance metrics. For instance, the training data may include simulated training data (e.g., training data obtained from simulated scenarios (e.g., load testing), inputs, configurations, test storage environments, QA environments, etc.).

Additionally, or alternatively, the model trainer(s) may perform unsupervised training techniques using production training data. By way of example, the model trainer(s) may train one or more components of a machine-learned model to perform query costing through unsupervised training techniques using an objective function (e.g., costs, rewards, heuristics, constraints, etc.). In some implementations, the model trainer(s) may perform a number of generalization techniques to improve the generalization capability of the model(s) being trained. Generalization techniques include weight decays, dropouts, or other techniques.

The query cancellation service 301 may utilize the query cancellation model 302 to receive a query 104, performance metrics 207, and access index data 306 to generate an output 303 indicating a query cost. For example, the query cancellation model 302 may receive a query 104 and access index data 306 to generate a static costs for the query 104. The static cost may indicate an objective estimate of computing resources to be consumed by continuing to execute a running query 104 or an objective estimate of computing resources to be consumed by allowing a queued query 104 to execute. For instance, the query cancellation model 302 may analyze the query 104 to identify the data associated with the query, the action to be taken on the data (e.g., an associated function), and determine based on the index data 306 a static cost for executing the query 104.

By way of example, the query cancellation model 302 may receive a query 104 and determine the query 104 is requesting retrieval (e.g., GET request, etc.) of data stored in column11 of table B. The query 104 may also indicate that the response should be sorted (e.g., SORT operation) based on an ascending order. The query cancellation model 302 may assign data operators an operation score. An operation score may include a pre-determined score (e.g., numerical value, etc.) associated with an objective estimated measure of computing resources needed to perform the operation. The operation score may be an integer, percentage, words, phrase, or any consistent indicator within a scale or scoring system. In some examples, a SORT operation may require more computing resources to complete than an insertion (e.g., INSERT) operation or a deletion (e.g., DELETE) operation, or other operations on data structures. For instance, a SORT operation may have a higher operation score than an insertion or deletion operation due to an inherent need for more computing resources to execute a SORT operator. The query cancellation model 302 may determine based on the SORT operator indicated by the query 104, that a high operation score should be assigned to the query 104.

The query cancellation model 302 may access index data 306 indicating locational and contextual information associated with data. For example, the index data 306 may include the location of data such as the storage device 210A, 210B, 210C, the table, column, or row where data is stored. In some examples, index data 306 may include the contextual information associated with data. For example, index data 306 may indicate the quantity or type (e.g., strings, integer, etc.) of values stored in respective columns, rows, and tables. For instance, index data 306 may indicate that column11 has two hundred unique values in row 18. Index data 306 may be generated by the storage system 202 as the storage system 202 stores data. In some examples, index data 306 may be updated as queries 104 or other computing processes interact with the data.

By way of example, the storage system 202 may receive data via an API request (e.g., query 104) from remote computing devices (e.g., clients 101A, 101B). For instance, a PUT request may transmit data type A to the storage system 202 for storage. The storage system 202 may receive the PUT request, determine a location where data type A associated with the PUT request should be stored and generate index data 306 indicating data type A has been indexed at a particular location. The index data 306 may include an indicator (e.g., pointer) pointing to the location of data. In some examples, index data 306 may increase the processing of the search engine 204 due to the locational references (e.g., pointers) of data associated with queries 104. For instance, the storage system 202 may receive a subsequent query 104 to interact with the data type A. The storage system 202 may quickly determine data type A is stored on table B, column11 based on index data 306 pointing to the location of data type A.

The query cancellation model 302 may analyze the index data 306 to determine the location and context of data associated with the query 104. For example, the query cancellation model 302 may determine, based on the index data 306 that column11, table B contains 50 unique values. The query cancellation model 302 may compute a static query cost based on the operation score (e.g., objective estimation) and the index data 306 (e.g., subjective input). For instance, the query cancellation model 302 may generate a low or inexpensive static query cost based on determining the SORT operator which includes a high operation score will only be applied to 50 unique values. In other examples, the query cancellation model 302 may generate a high or expensive static query cost based on an operation score and index data 306. For instance, column11, table B may include 2 million unique values. The query cancellation model 302 may generate, based on the high operation score, and index data 306 indicating a large number of values to sort, a high or expensive static query cost for executing the query 104.

While examples herein describe operation scores and static query costs as high, expensive, low, or inexpensive, the operation score and static query cost may be associated with numerical values, words, key phrases, identifiers, or any measure of computing resources. Additionally, or alternatively, the calculation of pre-determined operation scores may be generated by the query cancellation model 302 and updated based on training data. For instance, the calculation of operation scores and static query costs may be based on linear equations, differential equations, exponential functions, or any type of mathematical equation.

The query cancellation model 302 may receive performance metrics 207 and generate, based on the performance metrics 207 and static query cost, a query cost associated with the query 104. Performance metrics 207 may be captured by the storage monitoring system 203 and include an associated latency, a CPU utilization, an associated running time, a queue of queries to be executed, or any other metrics which indicate the health or performance of the storage system 202. The query cost may indicate a performance impact of cancelling a running query 104 or a query 104 queued for execution by the storage system 202. For example, the storage system 202 may be executing a first query 104, receive a second query 104, and the query cancellation model 302 may generate query costs to determine the first query 104 should be cancelled to prevent predicted performance issues from executing the second query. In some examples, the query cancellation model 302 may determine a currently running query 104 is consuming considerable CPU utilization and is causing higher latency for the storage system 202. The query cancellation model 302 may generate a query cost by determining a high probability of the storage system improving performance (e.g., recovering) by cancelling the query 104. In other examples, the query cancellation model 302 may receive redundant queries 104 associated with a high query cost which have caused previous performance issues. The query cancellation model 302 may proactively cancel queries 104 to prevent performance issues.

By way of example, the query cancellation model 302 may receive a query 104 and generate a static query cost for the query 104 by analyzing the query 104 (e.g., identifying the data, determining an operation score, etc.) and accessing index data 306. The query cancellation model 302 may receive performance metrics 207 indicating performance of the storage system 202. For instance, the performance metrics 207 may indicate the storage system 202 is executing 10 queries concurrently and is operating at an 80% CPU utilization. The performance metrics may also indicate that the storage system 202 has an average running time of 750 milliseconds (e.g., long running queries 104). The query cancellation model 302 may generate respective query costs for the 10 queries 104 and determine 4 of the running queries 104 are consuming 78% of the storage systems 202 CPU utilization. For instance, the query cancellation model 302 may generate high query costs for the 4 running queries 104. High query costs may be associated with increasing utilization, latency, running time, etc. of the storage system 202. For example, high query costs may be associated with adversely increasing one or more performance metrics 207 by 10-20%. In some examples, high query costs may be associated with adversely increasing one or more performance metrics by 25% or more. In other examples, a high query cost may be associated with any adverse performance impact of the storage system 202.

The query cancellation model 302 may also generate a high query cost by determining an increased probability of performance degradation improvement by the storage system 202 by cancelling the query 104. For instance, the query cancellation model 302 may determine there is a high probability of decreasing the average running time and CPU utilization by cancelling the 4 queries. The query cancellation model 302 may determine that decreasing the running time and CPU utilization will improve the performance of the storage system 202.

The query cancellation model 302 may generate high query costs for the 4 running queries 104 and output 303 data indicating the high query costs. The query cost may be an estimation of the computing resources necessary to continue executing the 4 running queries 104. In some examples, the query costs may be an estimation of the computing resources that may be preserved or reallocated by cancelling the 4 running queries 104. For instance, the query cost may be a numerical value, percentage, or any consistent measurement unit. In some examples, query costs may be high, low, expensive, cheap, etc. By way of example, a high or expensive query cost may be a numerical value 7 or above on a scale of 1-10, a moderate or fair query cost may be a numerical value 3-6 on a scale of 1-10, and a low or cheap query cost may be a numerical value of 3 or lower on a scale of 1-10. The query costs may be any integer, percentage, words, phrase, or any consistent indicator within a scale or scoring system.

The query cancellation service 301 may include a query cancellation manager 304 configured to receive the output 303 indicative of the query cancellation score and cancel, based on the output (e.g., query cost) the 4 running queries 104 before completing execution of the queries 104. For example, the query cancellation manager 304 may include software running on one or more servers of the storage system 202. In some examples, the query cancellation manager 304 may be implemented on one or more controller nodes 208 of the search engine 204. In other examples, the query cancellation manager 304 may be implemented as a standalone middleware service.

The query cancellation manager 304 may receive the output 303 indicating high query costs for the 4 running queries 104 and determine whether the queries 104 should be cancelled based on the query cost. For instance, the query cancellation manager 304 may determine the query cost meets or exceeds a query cost threshold. For example, the query cancellation model 302 may generate a query cost of 7 out of 10 for the 4 running queries 104 and determine based on a cancellation threshold of 7 that the 4 running queries 104 should be cancelled. In some examples, the query cancellation manager 304 may determine the query costs satisfies a recovery probability range and determine the queries 104 should be cancelled. For instance, a query cost may be associated with a 65% probability of improving (e.g., recovering) one or more performance metrics 207 and the query cancellation manager 304 may determine, based on a recovery probability range of 50% or higher, the queries 104 should be cancelled.

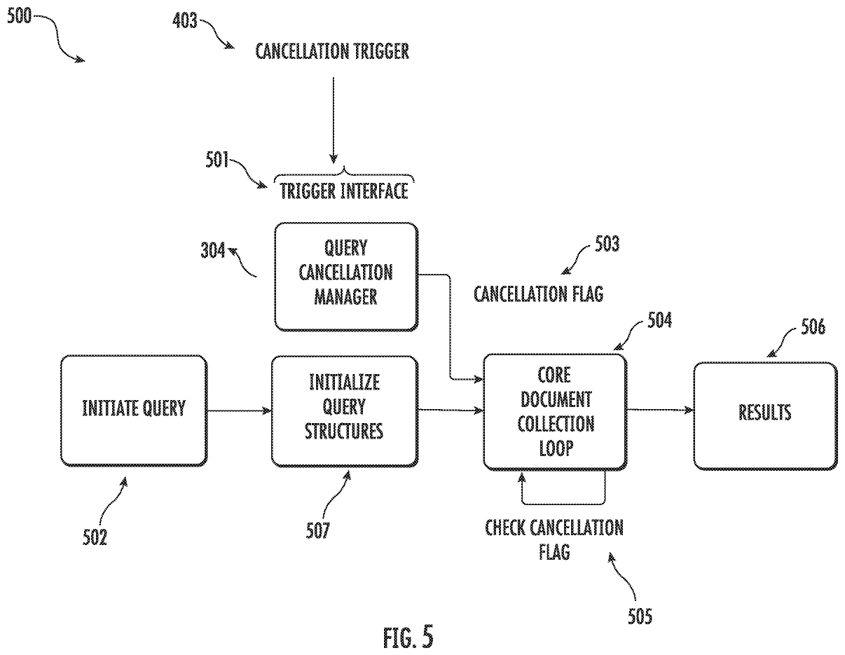

The query cancellation manager 304 may determine the 4 running queries should be cancelled based on the query cost (e.g., output 303) and generate output 305 indicating the determination to cancel the 4 running queries 104. In some examples, the output 305 may include one or more command instructions executable by the search engine 204 (e.g., controller nodes 208, etc.) to cancel the running queries 104 (e.g., via the search nodes 208A, 208B, 208C). For instance, the output 305 may include a cancellation flag to cancel the queries 104. For example, a cancellation flag may include data indicating that the search engine 204 should cancel the 4 running queries. An example of a cancellation flag is further described with reference to FIG. 5.

In another example, the query cancellation model 302 may determine a probability of the storage system 202 decreasing performance by executing a received query 104. By way of example, the query cancellation model 302 may determine based on performance metrics 207 that the storage system 202 is operating at an optimized level (e.g., 15% CPU utilization, optimized latency, etc.) and is concurrently executing a first query is associated with an expensive (e.g., above average) query cost, a second query is associated with a moderate (e.g., average) query cost, and a third query is associated with a cheap (e.g., below average) query cost. The query cancellation model 302 may receive a fourth query and generate a high query cost based on determining the fourth query is associated with deleting 1 million duplicate values across a plurality of storage devices 210A, 210B, 210C. The query cancellation model 302 may determine the fourth query 103 will be a long running query and will consume an estimated 70% CPU utilization.

In some examples, the query cancellation model 302 may determine there is an increased probability of the fourth query causing performance issues. For example, long running queries 104, which increase CPU utilization above 90%, may cause latency issues for the first, second, and third queries. For instance, the query cancellation model 302 may generate an expensive query cost indicating an 80% probability of degradation of the storage system 202. The query cancellation model 302 may generate an expensive query cost and output 303 data indicating the fourth query is expensive.

The query cancellation manager 304 may receive the output 303 and determine based in the query cost indicating the high probability of the storage system experiencing degradation and determine the probability exceeds a degradation probability threshold. For instance, the query cancellation manager 304 may determine, based on a 75% degradation probability threshold, the fourth query should be cancelled. The query cancellation manager 304 may output 305 data indicating the search engine 204 (e.g., controller node 208) should not queue the fourth query for execution and should generate a response (e.g., cancellation response, response code, etc.) to the remote computing device 201.

In another example, the query cancellation model 302 may determine a query 104 should Search nodes 208A, 208B, 208C operators, etc.) to interact with data. In some examples, the query cancellation model 302 may generate sub-query costs for the respective requests included in a query 104 and determine one or more sub-requests (e.g., partial query) should be cancelled.

By way of example, the query cancellation model 302 may receive a query 104 including a POST request to store (e.g., insertion operator) new data in the storage system 202 and update (e.g., update operator) a global data type which includes 5 million distinct values. The query cancellation model 302 may generate a sub-query cost for the insertion operation and a sub-query cost for the update operation. The query cancellation model 302 may generate a low or inexpensive sub-query cost for the insertion operation due the routine nature of the operation, available storage space for the new data, available computing resources, etc. The query cancellation model 302 may generate a high or expensive sub-query cost for the update operation due to the compute intensive operation, the large number of distinct values, etc. In some examples, the query cancellation model 302 may generate output 303 indicating the sub-query costs for the query 104.

The query cancellation manager 304 may receive the output 305 indicating the sub-query costs for the query 104 and determine the query 104 should be partially cancelled. For instance, the query cancellation manager 304 may determine the update operation should be cancelled based on the expensive sub-query cost. In some examples, the query cancellation manager 304 may output 305 data indicating that only the insertion operation (e.g., sub-query) should be executed by the search engine 204 and a partial response should be transmitted to the remote computing device 201.

In some examples, running queries 104 which have been cancelled may produce a partial response. For instance, a running queries 104 which is problematic (e.g., rogue query) may be cancelled by the query cancellation service 301 after executing for 2 minutes. In some examples, the rogue query 104 may have been partially executed. The query cancellation service 301 may cancel the query 104 and a response indicative of the executed portion (e.g., partial response) may be transmitted to the remote computing device 201. In some examples, partial responses may be associated with one or more response codes.

The query cancellation service 301 may cancel queries 104 proactively (e.g., prior to execution), or retroactively (e.g., after execution has begun). As described herein, the query cancellation model 302 may receive feedback data 307 indicating updated performance metrics of the storage system 202. For instance, the feedback data 307 may indicate a cancellation score. A cancellation score may indicate a measure of accuracy between the query cost (e.g., the estimated impact of performance) with an actual impact of performance. For instance, the cancellation score may indicate a determination to cancel a query 104 based on the generated query cost was inaccurate and should be updated. The cancellation score may be an integer, percentage, or any value which indicates a standard deviation between the predicted performance impact and the actual performance impact.

By way of example, the query cancellation service 301 may determine a running query 104 should be cancelled based on a query cost of 9 out of 10 indicating a running resource intensive operation causing performance issues and a high probability of system recovering by cancelling the query 104. The search engine 204 may cancel the query 104 and the storage system 202 may continue to experience performance issues. For instance, the storage monitoring system 203 may collect performance metrics 207 indicating consistently adverse system performance. The query cancellation model 302 may generate a low (e.g., poor) cancellation score based on the feedback data 307 indicating the probability of the system recovering (e.g., determination to cancel the query 104) was an inaccurate prediction. The query cancellation model 302 may utilize the feedback data 307 indicating the low cancellation score to update one or more parameters to increase the accuracy of generating query costs.

In another example, the query cancellation model 302 may generate a low or inexpensive query cost for a query 104 and generate output 303 indicating the query cost. The query cancellation manager 304 may determine based on the query cost that the query 104 should be cancelled and the query 104 may bypass the query cancellation manager 304. For instance, the query cancellation manager 304 may generate output 305 which excludes queries 104 that should not be cancelled. In some examples, the search engine 204 may queue the query 104 for execution and generate performance metrics 207 indicating an actual performance impact of the storage system 202 by executing the query 104. For instance, the search engine 204 may execute the query 104 and the query may consume a higher utilization, increase in latency, or yield a longer running time than predicted. For example, a low query cost may be generated for a query 104 by predicting no increase in CPU utilization and after executing the query 104 performance metrics 207 may indicate the CPU utilization increased by 40%.

The query cancellation model 302 may receive feedback data 307 indicating a null cancellation score indicating, based on the query cost, the query 104 would not cause adverse performance impact. For instance, the query cancellation model 302 may receive the feedback data 307 indicating the query 104 has begun execution and generate an updated query cost for the query 104 based on the null cancellation score. In some examples, the query cancellation model 302 may generate an updated cost based on performance metrics 207 (e.g., cancellation score) while the query 104 is still running. For instance, an updated query cost may be generated and the query cancellation manager 304 may determine, based on the updated query cost that the query 104 should be cancelled before completing execution of the query 104. In some examples, the query 104 may finish executing and the query cancellation model 302 may generate, based on feedback data 307 (e.g., cancellation score) an updated query cost. The updated query cost may be generated for a repeated query 104 including the same or similar parameters (e.g., operators, data, etc.). In some examples, the query cancellation score may be utilized to measure improvements in the accuracy of query cost generation and the determination to cancel queries.

In some examples, the query cancellation model 302 may update one or more parameters based on feedback data 307. By way of example, the query cancellation model 302 may update one or more computational inputs such as the operation score metrics. The query cancellation model 302 may assign a low integer value to an insertion operation when generating a query cost for a novel data type. The query cancellation model 302 may receive feedback data 307 indicating the insertion operation should be associated with a higher operation score due to higher than predicted computing resources being utilized in executing the operation. The query cancellation model 302 may adjust any input parameters based on feedback data 307 to generate more accurate query costs.

In some examples, the query cancellation service 301 may proactively cancel queries 104 which have previously caused performance issues for the storage system 202. By way of example, the query cancellation service 301 may generate an expensive query cost for a rogue query which consumed 90% CPU utilization for the storage system 202 and caused an outage. The query cancellation service 301 may receive the same rogue query 104 which caused the outage and proactively cancel the rogue query 104 each time the storage system 202 receives the query 104 to prevent future outages or performance issues. In some examples, the query cancellation service 301 may store data indicating a list of known problematic queries 104. For instance, the query cancellation service 301 may not need to recompute a query cost for known problematic queries 104.

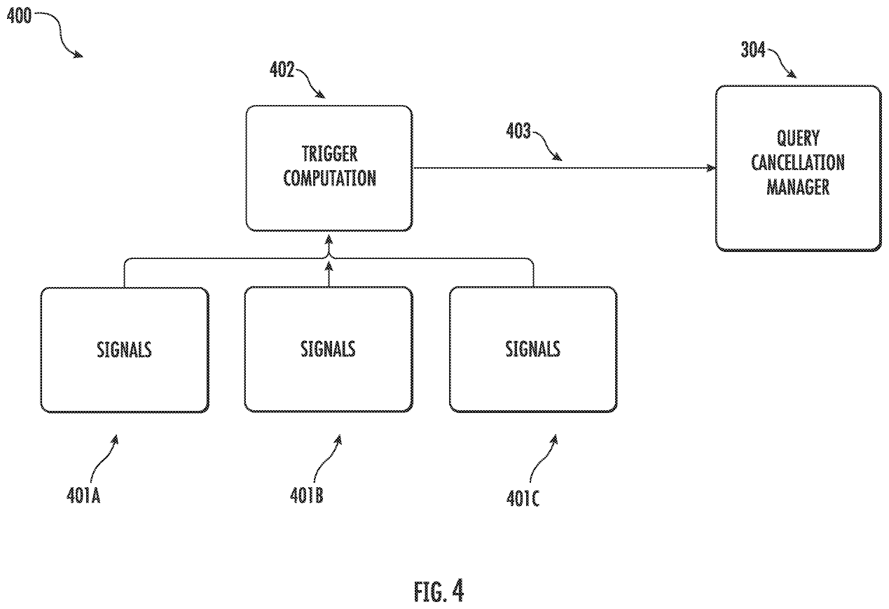

By way of example, the query cancellation service 301 may receive a query 104 and compare the query 104 to a list of known problematic queries 104. An early termination controller may determine the query 104 matches a known problematic query 104 and cancel query 104. An example of an early termination controller is further described with reference to FIG. 4. The cancelled problematic query 104 may bypass the query cancellation model 302 and be transmitted directly to the query cancellation manager 304. In some examples, immediately cancelled problematic queries 104 may be associated with a custom or standard response code.

FIG. 4 depicts an example dataflow pipeline according to example aspects of the present disclosure. The example dataflow pipeline 400 is described with an example implementation in which the query cancellation manager 304 receives a cancelling trigger to 403 to cancel running or queued queries 104. The cancellation trigger 403 may be generated based on a trigger computation 402. In some examples, the trigger computation 402 is implemented by the query cancellation model 302. In other examples, the trigger computation 402 is implemented via one or more containers. For instance, the trigger computation 402 may include standalone software running on one or more servers or in one or more containers within the storage system 202.

In some examples, the trigger computation may include a rules-based model including a heuristic set of rules. The set of rules may be developed to evaluate a plurality of signals 401A, 401B, 401C as described herein.

In some examples, the trigger computation 402 may include one or more machine-learned models. This can include one or more machine-learned models trained to determine whether a signal 401A, 401B, 401C is determinative in generating a cancellation trigger. The trigger computation 402 can be or can otherwise include various machine-learned models such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks. The one or more models can be trained through the use of one or more model trainers and training data. The model trainers can be trained using one or more training or learning algorithms to train the models to determine signals 401A, 401B, 401C result in a cancellation trigger.

The trigger computation 402 may include software configured to receive signals 401A, 401B, 401C indicating that a query 104 should be cancelled and generate one or more cancellation triggers 403 to cancel the query 104. In some examples, the trigger computation 402 may determine a query 104 should be cancelled prior to transmitting the cancellation trigger 403 to the query cancellation manager 304. For instance, the trigger computation 402 may receive one or more signals 401A, 401B, 401C and determine, based on a set of rules, to cancel one or more queries 104. The signals 401A, 401B, 401C may be generated by one or more controllers configured to receive input and generate signals 401A, 401B, 401C.

For example, the signals 401A, 401B, 401C may be associated with a plurality of cancellation controllers. For instance, signal 401A may be associated with an early termination controller, 401B may be associated with a user-context-based controller, and 401C may be associated with a utilization controller. The cancellation controllers may include software configured to detect specified or pre-determined conditions which may cause performance issues within the storage system 202. For example, the early termination controller may be configured to detect rogue queries (e.g., queries which have previously or repeatedly caused performance issues). The user-context-based controller may be configured to detect queries 104 specified or predetermined by microservice owners or custodians as queries which should cancelled. For instance, specific queries 104 may request to interact with an API endpoint which has been deprecated or with data which has been archived. Queries 104 which request access to data assets which are not readily available may cause performance issues for the microservices. The utilization controller may be configured to detect a CPU utilization percentage and automatically cancel queries which are received by the storage system 202 or are currently running which exceed the CPU utilization percentage.

By way of example, signal 401A may be generated by an early termination controller. An early termination controller may include software running in one or more container or on one or more nodes with the storage system 202. The early termination controller may be configured to determine queries which should be terminated prior to execution. For instance, the early termination controller may determine whether a query received by the storage system 202 is a problematic query 104 (e.g., caused previous performance issues). The early termination controller may detect problematic queries 104 and generate signal 401A to cancel the query 104. In some examples, the trigger computation 402 may receive the signal 401A and determine the query 104 may be immediately cancelled. For instance, the trigger computation 402 may generate a cancellation trigger 403 based on receiving the signal 401A.

In some examples, the trigger computation 402 may receive the signal 401A and wait for additional signals 401B, 401C before generating a cancellation trigger. By way of example, the early termination controller may detect a rogue or problematic query 104 and generate a signal indicating the receipt of a known problematic query. In some examples, a user-context-based controller may generate a signal 401B indicating that the problematic query 104 should be executed. For instance, a user-context-based controller may allow microservice owners or custodians to provide input into the query cancellation service 301 which indicate queries 104 that may be cancelled or queries which may not be cancelled (e.g., prioritized queries 104, etc.). For example, the user-context-based controller may include one include software running in one or more container or on one or more nodes with the storage system 202 or the worker nodes 102A, 102B, 102C. In some examples, the user-context-based controller may detect queries 104 identified by a microservice owner or custodian and generate signals 401B based on the input provided.

As described herein, the trigger computation 402 may receive a signal 401A from the early termination controller, a signal 401B from the user-context-based controller, and determine, based on a set of rules whether to generate a cancellation trigger 403. Example rules may include Boolean logic or software code (e.g., scripts) which results in a binary result. For instance, a rule may indicate that a cancellation trigger 403 is true (e.g., generate cancellation trigger) if signal 401A is received and signal 401B and signal 401C are null. In some examples, the trigger computation 402 may indicate that a cancellation trigger is false (e.g., do not generate cancellation trigger) if signal 401A is received and signal 401B or signal 401C is not null. The query computation 402 may include a plurality or rules and rule combinations and determine whether to generate a cancellation trigger 403.

The cancellation trigger 403 may be associated with a query cost. For example the query cancellation manager 304 may be configured to receive input indicating a query cost. In some examples, the query cancellation trigger 403 may indicate a query cost which consistently results in a determination by the query cancellation manager 304 to cancel the query 104.

By way of example, the cancellation trigger 403 may indicate the maximum threshold, probability range, or query cost associated with the respective query. In some examples, the query cancellation manager 304 may receive the cancellation trigger and determine the query 104 should be cancelled based on the maximum query cost. For instance maximum query costs may not require any additional processing to cancel queries 104 and may automatically generate output 305 to cancel the query. For instance, the trigger computation 402 may invoke a cancellation trigger 403 to automatically cancel the query 104 without any additional processing.

In some examples, the query cancellation manager 304 may generate a cancellation flag to indicate a running query 104 should be cancelled immediately. For instance, the cancellation flag may be associated with a cancellation status which updates the status of running queries 104 to cancelled to cancel the query 104 more quickly. An example of a cancellation flag is further described with reference to FIG. 5

FIG. 5 depicts an example dataflow pipeline according to example aspects of the present disclosure. The example dataflow pipeline 500 is described with an example implementation in which the query cancellation manager 304 receives a cancellation trigger 403, generates a cancellation flag 503, and cancels the query 104 to generate a result 506. The dataflow pipeline 500 may include a query initiation 502 process in which a query is received by the storage system 202 and initialization of query structures process 507 in which a query is analyzed by the search engine 204 to determine to location and action to be taken on the data structure specified by the query 104. In some examples, the query initiation process 502 and initialization of query structures process 507 may be executed by the search engine 204 to prepare to execute the query 104. For instance, initialization of query structures 507 may be executed by the controller node 208. For example, initialization of query structures 507 may include the process of assigning the query 104 to a search node 208A, 208B, 208C.

The dataflow pipeline 500 may include a documentation collection loop 504 in which the controller node 208 polls (e.g., sends request to see if any information has changed) the query cancellation manager 304. For instance, the controller node 208 may consistently look for updates from the query cancellation manager 304 which may indicate output 305 or a cancellation flag 503. A cancellation flag 503 may indicate an update to the status of a running query 104. In some examples, the documentation collection loop 504 may include a specific check to determine whether a cancellation flag 503 has been generated for any of the queries 104 currently running. For instance, the documentation collection loop 504 may include a check cancellation flag process 505 to check for cancellation flags 503 output but the query cancellation manager 304.

By way of example, the search engine 204 may receive a query 104, perform query initiation 502, initialization of query structures 507, and begin executing the query 104. In some examples, the search engine 204 may generate a status to indicate current information associated with the query. For instance, queries 104 which have been queued for execution may include a status of “queued” or “pending”, queries 104 which have started executing may include a status of “running” or “execution”, and queries 104 which have finished executing may include a status of “complete” or “finished”. In some examples, queries 104 may have a “cancelled” status.

For instance, the query cancellation manager 304 may generate output 305 indicating one or more command instructions to cancel the query 104. For example, the output 305 may cause the search engine 204 to update the status of a running query 104 to “cancelled”. In some examples, the query cancellation manager 304 may receive a cancellation trigger 403 via a trigger interface 501. A trigger interface may include software code with the query cancellation manager 304 configured to receive cancellation triggers 403. For instance, the cancellation interface 501 may indicate that no additional processing is required to cancel the query 104. For example, the cancellation interface 501 may receive the cancellation trigger 403 and generate a cancellation flag 503 (e.g., updated status data). The cancellation flag 503 may provide updated status data being polled by the documentation collection loop 504. For instance, the cancellation flag 503 may update the status of the running query 104 to “cancelled” to prevent any additional allocation of computing resources from executing the query 104. In some examples, the cancellation flag 503 may provide an alternative method of cancelling queries 104 more quickly.

The search engine 204 may receive the updated “cancelled” status for running queries 104 and output a result 506. In some examples, the result 506 may include a query response 211. In some examples, the result 506 may be associated with a partial response. For instance, the result may indicate the partial query results executed prior to the query 104 being cancelled. In some examples, the result 506 may be associated with a response code. For instance, the response code may indicate a partial response code or a cancellation response code indicating the query 104 has been cancelled.

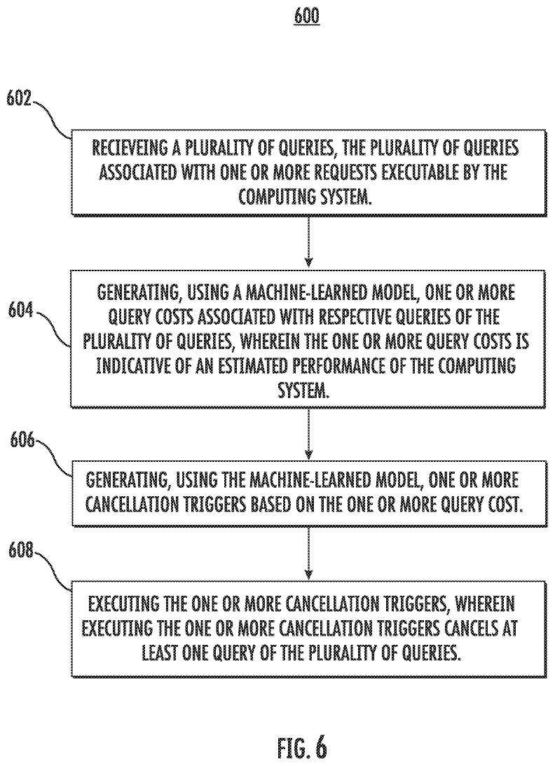

FIG. 6 depicts a flowchart diagram of an example method according to example aspects of the present disclosure. One or more portion(s) of the method 600 may be implemented by one or more computing devices such as, for example, the computing devices/systems described in FIGS. 2, 3, 4, 5, etc. Moreover, one or more portion(s) of the method 600 may be implemented as an algorithm on the hardware components of the device(s) described herein. For example, a computing system may include one or more processors and one or more non-transitory, computer-readable media storing instructions that are executable by the one or more processors to cause the computing system to perform operations, the operations including one or more of the operations/portions of method 600. FIG. 6 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure.

In an embodiment, the method 600 may include a step 602 or otherwise begin by receiving a query, the query associated with one or more requests executable by the computing system. For instance, one or more remote computing devices 201 may transmit one or more queries 104 to a storage system 202 to retrieve, store, or otherwise interact with data. The storage system 202 may include a query cancellation service 301 configured to cancel queries 104 which may cause performance degradation for the storage system 202. The query cancellation service 301 may include a query cancellation model 302 which receives the queries 104, performance metrics 207, and accesses index data 306.

The query cancellation model 302 may receive a query 104 and identify a field and an operator associated with the query 104. For example, the query 104 may indicate a deletion operation should be executed against data type B to delete duplicate values within the storage system 202. The query cancellation model 302 may access index data 306 indicating (e.g., pointing) data type B is located on column C within the storage system 202. In some examples, the index data 306 may include contextual information. For instance, index data 306 may indicate that column C contains sting values and includes 100,000 duplicate values.

The query cancellation model 302 may generate a static query cost based on analyzing the query 104 (e.g., identifying the field and operator) and accessing index data 306 (e.g., determining the location of data where the query 104 will be executed). For example, the query cancellation model 302 may determine a deletion operator is associated with a pre-determined operation score. The pre-determined operation score may indicate an estimated measure of computing resources required to execute the operation. In some examples, a deletion operation score may be associated with a moderate (e.g., average) exhaustion of computing resources. The query cancellation model 302 may generate, based on the pre-determined operation score and the index data 306 indicating the volume and location of data to which the deletion operation must be executed, a static query cost. The static query cost may indicate an estimated measure of computing resources which may be consumed by executing the query 104. By way of example, the query cancellation model 302 may generate a high static query cost for the query 104 due to the moderate operation score and the large number of duplicate values.

In an embodiment, the method 600 may include a step 604 or otherwise continue by generating, using a machine-learned model, a query cost for the query, wherein the query cost is indicative of an estimated performance of the computing system. For instance, the query cancellation model 302 may receive performance metrics 207 indicating a performance of the storage system 202. In some examples, performance metrics 207 may indicate the storage system 202 is experiencing decreased performance (e.g., degradation). For example, the storage system 202 may be executing a plurality of queries 104 and may be operating at a 97% utilization rate.

By way of example, the query cancellation model 302 may generate, based on the static query cost and the performance metrics 207 a query cost indicative of the estimated performance of the storage system 202. For instance, the query cancellation model 302 may generate a high query cost associated with the query 104 based on the performance metrics indicating limited computing resources available and the current degradation. In some examples, the query cancellation model 302 may determine a high probability that storage system 202 will experience additional performance issues by executing the query 104. In some examples, the query cancellation model 302 may determine a high probability that the storage system 202 may improve performance if the query is not executed. In other examples, the query cancellation model 302 may determine the storage system 202 may exceed 100% utilization and cause an outage if the query is executed. The query cancellation model 302 may generate a high query cost based on the likelihood of poor performance of the storage system and output 303 data indicating the query 104 should be cancelled. For instance, the query cancellation model 302 may generate a cancellation trigger indicating the query should be cancelled based on the query cost.

In an embodiment, the method 600 may include a step 606 or otherwise continue by, based on the query cost, cancelling the query before completing execution of the one or more requests by the computing system. For instance, the query cancellation service 301 may include a query cancellation manager 304. The query cancellation manager 304 may include one or more computing resources configured to receive output 303 and execute cancellation triggers XXX to cancel queries 104.

By way of example, the query cancellation manager 304 may analyze the output 303 and determine, based on the cancellation status, the query 104 should be cancelled. The query cancellation manager 304 may generate a cancellation trigger based on the cancellation status (e.g., query cost) to cancel the query 104. In some examples, the query cancellation manager 304 may invoke the cancellation trigger XXX to cancel the query 104.

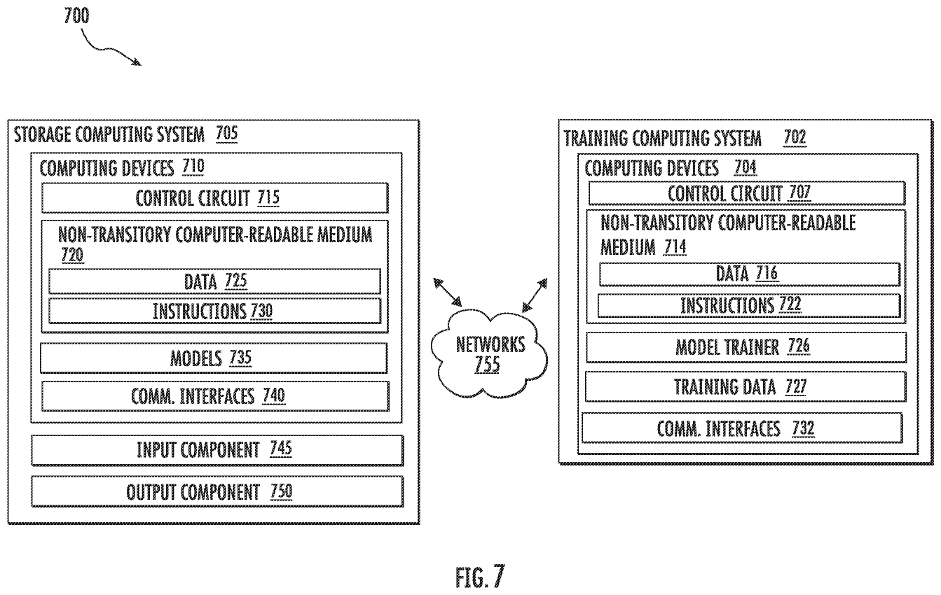

FIG. 7 depicts a block diagram of an example system 700 for implementing systems and methods according to example embodiments of the present disclosure. The system 700 includes a storage computing system 705 (e.g., storage system 202), and a training computing system 702 communicatively coupled over one or more networks 755.

The storage computing system 705 may include one or more computing devices 710 or circuitry. For instance, the storage computing system 705 may include a control circuit 715 and a non-transitory computer-readable medium 720, also referred to herein as memory. In an embodiment, the control circuit 715 may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In an embodiment, the control circuit 715 may be programmed by one or more computer-readable or computer-executable instructions stored on the non-transitory computer-readable medium 720.

In an embodiment, the non-transitory computer-readable medium 720 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium 720 may form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick.

The non-transitory computer-readable medium 720 may store information that may be accessed by the control circuit 715. For instance, the non-transitory computer-readable medium 720 (e.g., memory devices) may store data 725 that may be obtained, received, accessed, written, manipulated, created, and/or stored. The data 725 may include, for instance, any of the data (e.g., log data) or information described herein. In some implementations, the storage computing system 705 may obtain data from one or more memories that are remote from the storage computing system 705.

The non-transitory computer-readable medium 720 may also store computer-readable instructions 730 that may be executed by the control circuit 715. The instructions 730 may be software written in any suitable programming language or may be implemented in hardware.

The instructions 730 may be executed in logically and/or virtually separate threads on the control circuit 715. For example, the non-transitory computer-readable medium 720 may store instructions 730 that when executed by the control circuit 715 cause the control circuit 715 to perform any of the operations, methods and/or processes described herein. In some cases, the non-transitory computer-readable medium 720 may store computer-executable instructions or computer-readable instructions, such as instructions to perform at least a portion of the method of FIG. 6.

In an embodiment, the storage computing system 705 may store or include one or more machine-learned models 735. For example, the machine-learned models 735 may be or may otherwise include various machine-learned models. In an embodiment, the machine-learned models 735 may include neural networks (e.g., deep neural networks) or other types of machine-learned models, including non-linear models and/or linear models. Neural networks may include feed-forward neural networks, recurrent neural networks (e.g., long short-term memory recurrent neural networks), convolutional neural networks or other forms of neural networks. Some example machine-learned models may leverage an attention mechanism such as self-attention. In an embodiment, the storage computing system 705 may implement multiple parallel instances of a single model.

The storage computing system 705 may include one or more communication interfaces 740. The communication interfaces 740 may be used to communicate with one or more other systems. The communication interfaces 740 may include any circuits, components, software, etc. for communicating via one or more networks (e.g., networks 755). In some implementations, the communication interfaces 740 may include for example, one or more of a communications controller, receiver, transceiver, transmitter, port, conductors, software and/or hardware for communicating data/information.

The storage computing system 705 may also include one or more user input components 745 that receives user input. For example, the user input component 745 may be a touch-sensitive component (e.g., a touch-sensitive user interface of a mobile device) that is sensitive to the touch of a user input object (e.g., a finger or a stylus). The touch-sensitive component may serve to implement a virtual keyboard. Other example user input components include a microphone, a traditional keyboard, cursor-device, joystick, or other devices by which a user may provide user input.

The storage computing system 705 may include one or more output components 750. The output components 750 may include hardware and/or software for audibly or visually producing content. For instance, the output components 750 may include one or more speakers, earpieces, headsets, handsets, etc. The output components 750 may include a display device, which may include hardware for displaying a user interface and/or messages for a user. By way of example, the output component 750 may include a display screen, CRT, LCD, plasma screen, touch screen, TV, projector, tablet, and/or other suitable display components.

The storage computing system 705 may train the models 735 via interaction with the training computing system 702 that is communicatively coupled over the networks 755. The training computing system 702 may be separate from the storage computing system 701 or may be a portion of the storage computing system 701.

The training computing system 702 may include one or more computing devices 704. In an embodiment, the training computing system 702 may include or is otherwise implemented by one or more server computing devices. In instances in which the training computing system 702 includes plural server computing devices, such server computing devices may operate according to sequential computing architectures, parallel computing architectures, or some combination thereof.

The training computing system 702 may include a control circuit 708 and a non-transitory computer-readable medium 714, also referred to herein as memory 714. In an embodiment, the control circuit 708 may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In an embodiment, the control circuit 708 may be programmed by one or more computer-readable or computer-executable instructions stored on the non-transitory computer-readable medium 714.

In an embodiment, the non-transitory computer-readable medium 714 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium may form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick.

The non-transitory computer-readable medium 714 may store information that may be accessed by the control circuit 715. For instance, the non-transitory computer-readable medium 714 (e.g., memory devices) may store data 716 that may be obtained, received, accessed, written, manipulated, created, and/or stored. The data 716 may include, for instance, any of the data (e.g., data logs) or information described herein. In some implementations, the training computing system 702 may obtain data from one or more memories that are remote from the training computing system 702.

The non-transitory computer-readable medium 714 may also store computer-readable instructions 722 that may be executed by the control circuit 708. The instructions 722 may be software written in any suitable programming language or may be implemented in hardware. The instructions may include computer-readable instructions, computer-executable instructions, etc.

The instructions 722 may be executed in logically or virtually separate threads on the control circuit 708. For example, the non-transitory computer-readable medium 714 may store instructions 722 that when executed by the control circuit 708 cause the control circuit 708 to perform any of the operations, methods and/or processes described herein. In some cases, the non-transitory computer-readable medium 714 may store computer-executable instructions or computer-readable instructions, such as instructions to perform at least a portion of the methods of FIG. 6.

The training computing system 702 may include a model trainer 726 that trains the machine-learned models 735 stored at the storage computing system 705 using various training or learning techniques. For example, the model 735 may be trained using a loss function. By way of example, for training data tiering model, the model trainer 726 may use a loss function. For example, a loss function can be backpropagated through the model(s) 735 to update one or more parameters of the model(s) 735 (e.g., based on query costing feedback data of the loss function). Various loss functions can be used such as mean squared error, likelihood loss, cross entropy loss, hinge loss, and/or various other loss functions. Query cost or operation score descent techniques can be used to iteratively update the parameters over a number of training iterations.

The model trainer 726 may train the models 735 in an unsupervised fashion. As such, the models 735 may be effectively trained using computer generated data for particular applications or problem domains, which improves performance and adaptability of the models 735.

The training computing system 702 may modify parameters of the models 735 (e.g., the query cancellation model 401) based on the loss function such that the models 735 may be effectively trained for specific applications in an unsupervised manner feedback data.

The model trainer 726 may utilize training techniques, such as backwards propagation of errors. For example, a loss function may be backpropagated through a model to update one or more parameters of the models (e.g., based on inaccurate query costs of the loss function). Various loss functions may be used such as mean squared error, likelihood loss, cross entropy loss, hinge loss, and/or various other loss functions. Performance metrics descent techniques may be used to iteratively update the parameters over a number of training iterations.

In an embodiment, performing backwards propagation of errors may include performing truncated backpropagation. The model trainer 726 may perform a number of generalization techniques (e.g., weight decays, dropouts, etc.) to improve the generalization capability of a model being trained. In particular, the model trainer 726 may train the machine-learned models 735 based on a set of training data 728.

The training data 728 may include computer generated training data for training in an unsupervised fashion. In an example, the training data 728 may performance metrics generated by the models 735. The training data 728 may be specific to a data set to help focus the models 735 on optimizing performance metrics.

The model trainer 726 may include computer logic utilized to provide desired functionality. The model trainer 726 may be implemented in hardware, firmware, and/or software controlling a general-purpose processor. For example, in an embodiment, the model trainer 726 may include program files stored on a storage device, loaded into a memory and executed by one or more processors. In other implementations, the model trainer 726 may include one or more sets of computer-executable instructions that are stored in a tangible computer-readable storage medium such as RAM, hard disk, or optical or magnetic media.

The training computing system 702 may include one or more communication interfaces 732. The communication interfaces 732 may be used to communicate with one or more other systems. The communication interfaces 732 may include any circuits, components, software, etc. for communicating via one or more networks (e.g., networks 755). In some implementations, the communication interfaces 732 may include for example, one or more of a communications controller, receiver, transceiver, transmitter, port, conductors, software and/or hardware for communicating data/information.

The one or more networks 755 may be any type of communications network, such as a local area network (e.g., intranet), wide area network (e.g., Internet), or some combination thereof and may include any number of wired or wireless links. In general, communication over a network 755 may be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 7 illustrates one example computing system that may be used to implement the present disclosure. Other computing systems may be used as well. For example, in an embodiment, the storage computing system 705 may include the model trainer 726 and the training data 728. In such implementations, the models 735 may be both trained and used locally at the storage computing system 705. In some of such implementations, the storage computing system 705 may implement the model trainer 726 to personalize the models 735.

Computing tasks discussed herein as being performed at certain computing device(s)/systems may instead be performed at another computing device/system, or vice versa. Such configurations may be implemented without deviating from the scope of the present disclosure. The use of computer-based systems allows for a great variety of possible configurations, combinations, and divisions of tasks and functionality between and among components. Computer-implemented operations may be performed on a single component or across multiple components. Computer-implemented tasks or operations may be performed sequentially or in parallel. Data and instructions may be stored in a single memory device or across multiple memory devices.

The technology discussed herein makes reference to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein may be implemented using a single device or component or multiple devices or components working in combination. Databases and applications may be implemented on a single system or distributed across multiple systems. Distributed components may operate sequentially or in parallel.

Aspects of the disclosure have been described in terms of illustrative implementations thereof. Numerous other implementations, modifications, or variations within the scope and spirit of the appended claims may occur to persons of ordinary skill in the art from a review of this disclosure. Any and all features in the following claims may be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. The term “or” and “and/or” may be used interchangeably herein. Lists joined by a particular conjunction such as “or,” for example, may refer to “at least one of” or “any combination of” example elements listed therein, with “or” being understood as “and/or” unless otherwise indicated. Also, terms such as “based on” should be understood as “based at least in part on.”

Those of ordinary skill in the art, using the disclosures provided herein, will understand that the elements of any of the claims discussed herein may be adapted, rearranged, expanded, omitted, combined, or modified in various ways without deviating from the scope of the present disclosure. Some implementations are described with a reference numeral, for example illustrated purposes and are not meant to be limiting.

What is claimed is:

1. A computing system comprising:
one or more processors; and
one or more memory resources storing instructions executable by the one or more processors to perform operations, the operations comprising:
receiving a query, the query associated with one or more requests executable by the computing system;
generating, using a machine-learned model, a query cost for the query, wherein the query cost is indicative of an estimated performance of the computing system; and
based on the query cost, cancelling the query before completing execution of the one or more requests by the computing system.

2. The computing system of claim 1, wherein generating a query cost for the query comprises:
accessing index data indicative of a location of data ingested by the computing system, wherein the data is associated with the query; and
identifying a field and an operator for the query, wherein the field is indicative of the location of the data based on the index data and the operator is indicative of an action to be taken on the data.

3. The computing system of claim 2, wherein generating a query cost for the query comprises:
predicting a static query cost based on the field and the operator, wherein the static query cost is indicative of computing resources to be consumed by executing the query;
receiving performance metrics associated with the computing system; and
generating the query cost based on the static query costs and the performance metrics.

4. The computing system of claim 3, wherein the performance metrics are indicative of at least one of: (i) an associated latency, (ii) a CPU utilization, (iii) an associated running time, or (iv) a queue of queries to be executed.

5. The computing system of claim 1, wherein the operations further comprise:
determining, based on the query cost, a probability of decreasing performance of the computing system by executing the query.

6. The computing system of claim 1, wherein the operations further comprise:
determining, based on the query cost, a probability of increasing performance of the computing system by cancelling the query.

7. The computing system of claim 1, wherein the machine-learned model is configured to:
receive feedback data associated with a cancellation score, wherein the cancellation score is associated with one or more cancelled queries; and
determine, based on the feedback data, one or more updated query costs associated with respective queries.

8. The computing system of claim 7, wherein the cancellation score is associated with an actual performance of the computing system in response to the one or more cancelled queries.

9. The computing system of claim 1, wherein the operations comprise:
generating a cancellation trigger based on the query cost; and
invoking the cancellation trigger, wherein invoking the cancellation trigger cancels the query.

10. The computing system of claim 9, wherein invoking the cancellation trigger comprises:
determining a type of cancellation trigger, wherein the type of cancellation trigger is associated with a signal to cancel the query; and
determining a cancellation controller from a plurality of cancellation controllers, based on the type of cancellation trigger.

11. The computing system of claim 10, wherein the plurality of cancellation controllers comprises at least one of: (i) an early termination controller, (ii) a user-context-based controller, or (iii) a utilization controller.

12. The computing system of claim 10, wherein the signal to cancel the query is indicative of a cancellation status associated with the query.

13. A computer implemented method comprising:
receiving a query, the query associated with one or more requests executable by the computing system;
generating, using a machine-learned model, a query cost for the query, wherein the query cost is indicative of an estimated performance of the computing system; and
based on the query cost, cancelling the query before completing execution of the one or more requests by the computing system.

14. The computer-implemented method of claim 13, wherein generating a query cost for the query comprises:
accessing index data indicative of a location of data ingested by the computing system, wherein the data is associated with the query; and
identifying a field and an operator for the query, wherein the field is indicative of the location of the data based on the index data and the operator is indicative of an action to be taken on the data.

15. The computer-implemented method of claim 14, wherein generating a query cost for the query comprises:
predicting a static query cost based on the field and the operator, wherein the static query cost is indicative of computing resources to be consumed by executing the query;
receiving performance metrics associated with the computing system; and
generating the query cost based on the static query costs and the performance metrics.

16. The computer-implemented method of claim 15, wherein the performance metrics are indicative of at least one of: (i) an associated latency, (ii) a CPU utilization, (iii) an associated running time, or (iv) a queue of queries to be executed.

17. The computer-implemented method of claim 13, further comprising:
determining, based on the query cost, a probability of decreasing performance of the computing system by executing the query.

18. The computer-implemented method of claim 13, further comprising:
determining, based on the query cost, a probability of increasing performance of the computing system by cancelling the query.

19. The computer-implemented method of claim 13, wherein the machine-learned model is configured to:
receive feedback data associated with a cancellation score, wherein the cancellation score is associated with one or more cancelled queries; and
determine, based on the feedback data, one or more updated query costs associated with respective queries.

20. A non-transitory computer-readable media storing instructions that are executable by one or more processors to cause the one or more processors to perform operations, the operations comprising:
receiving a query, the query associated with one or more requests executable by the computing system;
generating, using a machine-learned model, a query cost for the query, wherein the query cost is indicative of an estimated performance of the computing system; and
based on the query cost, cancelling the query before completing execution of the one or more requests by the computing system.
